(19) United States
(12) Patent Application Publication
(10) Pub. No.: US 2006/0243300 A1
(43) Pub. Date: Nov. 2, 2006

(54) Method for cleaning lithographic apparatus

(76) Inventors: Patrick Klingbeil, Berlin (DE); Joerg Pitschke, Dresden (DE); Anja Bonness, Dresden (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 11/115,402

(22) Filed: Apr. 27, 2005

(51) Int. Cl. B08B 3/12; B08B 7/04; B08B 7/00

(52) U.S. Cl. 134/1; 134/18; 134/19

(57) ABSTRACT

A method is provided for cleaning a photo-mask by placing the photo-mask in an evacuated chamber for a certain period of time.

### FIELD OF THE INVENTION

The present invention relates to a method for cleaning a lithographic apparatus.

### BACKGROUND

The term “lithographic apparatus” as used hereinafter should be broadly interpreted as referring to a device that is used in a method for patterning semiconductor substrates. An example of such a lithographic device is a mask, also called a photo-mask or “reticle”. The concept of a mask is well known in lithography, and it includes mask types such as binary, alternating phase-shift and attenuated phase-shift, as well as various hybrid mask types. The present invention especially relates to masks used in UV lithography, and especially with a wavelength of less than 250 nm.

In the manufacturing of semiconductor integrated circuits, a layout design is usually transferred to a mask comprising a glass or quartz substrate and a metal layer deposited thereon. This transfer of the layout is a common step in the manufacturing of semiconductors and is well known to a person skilled in the art. Such a mask is placed over a semiconductor substrate coated with a photo-resist, which changes its chemical structure upon irradiation. By irradiating the semiconductor substrate over a mask which has a circuit pattern corresponding to an individual layer of the integrated circuit (IC), this pattern is imaged onto a target portion coated with radiation sensitive material, also known as photo-resist or resist on its top surface.

Although lithographic apparatus are operated in clean rooms and then flushed with clean air, contamination of the apparatus still occurs and, depending on the location and type of contaminants, can cause various problems. For example, inorganic contaminants on the mask, which originate from the air in the clean room or from other manufacturing processes, as well as from transportation and storage of the mask, causes localized absorption which leads to errors and improper imaging of mask features or even printing of marks in what should be blank areas. Furthermore contamination also originates from the processing chamber, such as from the gas-reaction products, deposits released from the wafer or from the oil of the vacuum pump. Such particulates also distort the alignment of the substrate and the photo-mask leading to localized focus errors known as hard spots.

Therefore, the masks used in the imaging of semiconductors should be cleaned in regular intervals. Current methods for removing contaminants from the surface of the photo-mask typically involve removing the affected item by wet cleaning methods.

Typical mask cleaning techniques rely on a set of chemistries similar to those used to clean wafers. One possibility is a solution called SPM (comprising sulphuric acid and hydrogen peroxide) which is also used for resist stripping or SCI-solution which is comprised of ammonium hydroxide and hydrogen peroxide for particle removal. A further rinse step is usually used to remove the cleaning solutions.

However, the chemistries involved in wafer cleaning are inherently damaging to the masks used in the lithographic patterning of semiconductors. This is especially true for the phase-shift masks (PSMs), where the cleaning can cause the loss of transmission and deteriorate the phase angle. Sulphuric acid, for example, has an etching effect that removes particles, but the same etching effect changes the masks phase angle and transmittance out of acceptable ranges. However, SCI-solutions still remain a preferred cleaning chemistry because of the solutions' substrate etching potential.

Therefore, there are different proposals available in the prior art to provide methods for cleaning masks which do not use liquid etching solutions.

For example, WO 02/42013 provides an apparatus for the removal of particles and contaminants from solid state surfaces such as optical masks, by providing a cleaning module, comprising a moving chuck on which the substrate is mounted, and a moving optical arm positioned over the chuck. The chuck holds the substrate, by suction for example, and the moving arm comprises optics, through which electromagnetic radiation, such as laser beam is conveyed and directed onto the substrate to clean the substrate surface. The contaminated area of the substrate is positioned under the cleaning arm by moving both the substrate and the cleaning arm in accordance with the coordinates of the particle. The arm motion is coordinated with the movement of the moving chuck so that the laser beam is directed locally to any point on the wafer surface. Laser energy is conveyed from the electromagnetic energy source, via the energy guide and the cleaning arm, and then the energy is targeted towards the particle according to the information received from the particle localization unit. The energy is fired so as to remove the particle from the substrate surface. The module, according to WO 02/42013, is rather complicated and requires an exact positioning of the contaminants to be removed, to fire the electromagnetic radiation directly onto the contaminants.

United States Patent Application No. 2002/0096195 provides a method for cleaning substrates, and especially semiconductor surfaces by creating a shockwave between a tip of a vacuum tube or a slot inside a clean gas environment, and the surface requiring cleaning, within a process chamber. A gas supply tube or slot supplies a gas stream toward the surface of the substrate. Along with a tube or a slot, a vacuum pump is provided so as to create a flow from within the tube to the outer portion of the tube to form a shockwave resulting in dislodging of the absorbed particles. The method of United States Application No. 0096195 is used to remove particles form the surface of reticles. The disadvantage of this process is that only physisorbed or chemisorbed particles, which are relatively loosely bound to the surface, are removed.

United States Application No. 2003/0184720 provides a method for cleaning components of a lithographic apparatus by using a cleaning device integrated into lithographic apparatus to clean a component thereof. The cleaning device is constructed in such a way as to use electromagnetic fields to liberate particles from the surface of a component to be cleaned.

### SUMMARY

The present invention includes a simple and fast method for cleaning photo-masks for UV-lithography.

The invention provides a method for removing contaminants from an optical photo-mask, comprising positioning the optical mask in a chamber, wherein the pressure of the chamber is set to be less than 100 mbar and leaving the optical mask in the chamber for a period of at least 30 minutes.

When photo-masks are used in a clean room for some time, these photo-masks develop crystal contaminants, which grow with every use of the photo-mask. Especially by 193 nm lithography, crystal growth is relatively high. Surprisingly, such crystals disappear after a certain period of time if the photo-mask is placed into a vacuum chamber evacuated to a pressure of less than 100 mbar. Not only is better cleaning achieved, by the use of the vacuum alone than by the use of chemical etching solutions, but also the tendency of crystal growth is reduced in the further use of the photo-mask.

Therefore, according to the present invention, a method is provided for removing contaminants from an optical photo-mask. Specifically, positioning the photo-mask in a chamber, wherein the pressure of the chamber is set to be less than 100 mbar, and leaving the photo-mask in the chamber for a period of at least 30 minutes.

An additional embodiment of the present invention includes a method for controlling the temperature of the photo-mask in the chamber. By controlling the temperature of the photo-mask, the treatment time of the photo-mask in the chamber is reduced as a higher temperature is employed. Therefore, in one aspect of the invention the temperature of the photo-mask in the chamber for cleaning such a mask is set to be in the range of approximately 20 to 80° C., and specifically in the range of approximately 60 to 80° C.

Furthermore, the invention includes a method for inspecting the surface of the photo-mask to determine whether or not the contaminants are still present. By inspecting the surface of the photo-mask, the end point of the treatment can be precisely determined.

Electro-magnetic radiation is also provided to speed up the evaporation of the crystal contaminants on the photo-mask. However, the electromagnetic radiation should be homogeneous over the entire surface of the photo-mask and not a focus electron or laser beam. Therefore, in another embodiment the electromagnetic radiation is an electron shower which is applied to the surface of the photo-mask to be cleaned. The energy of the electron shower is set to be above approximately 200 eV. Furthermore, if desired a focused beam of electromagnetic radiation or charged particles is used.

In another aspect of the present invention, the photo-mask to be cleaned also has a pellicle mounted thereon. The purpose of the pellicle is to keep the contaminant particles from the surface of the photo-mask (reticle).

A standard pellicle comprises a frame with a fixed membrane on top of the frame. Usually the pellicle is mounted to the base plate of the reticle by glue and cannot be dismantled without destroying the pellicle and leaving glue residue on the mask. A disadvantage of this process is that the rest of the glue holding the pellicle on the photo-mask has to be removed, so that relatively strong chemicals and a wet etching process can be applied.

According to the present invention, it is preferred that the pellicle is separated from the frame. The frame is constructed similar to a normal pellicle frame and is glued to the mask without the membrane. The membrane is then fixed to the frame by screws and a gasket.

In an alternative embodiment, a lower frame that is glued to the mask and an upper frame which is fixed to the membrane are employed. These frames are then connected through screws and a gasket or by similar sorts of seals, for example, bayonet connectors. The advantage of this approach would be that the upper part from the pellicle can be removed from the mask without generating glue residue which would make a cleaning necessary. The mask with the affixed frame can then be cleaned with an electron shower or a water rinse, for example. Afterwards a new membrane can be fitted easily to the lower frame. Potentially it would even be possible to reuse the upper frame part with the membrane.

However, a problem arises when contaminates, such as crystals, which grow with every use of the photo-mask, appear below the surface of the pellicle. According to the prior art, a pellicle has to be dismounted from the photo-mask and the photo-mask must be cleaned without the pellicle.

A disadvantage of this process is that the rest of the glue holding the pellicle on the photo-mask has to be removed so that the relatively strong chemicals and wet etching process can be applied. According to the present invention, the pellicle does not have to be removed, since the pellicle either comprises a hole from which the contaminants present on the photo-mask can escape or there is a valve provided so that the pressure between the pellicle and the photo-mask can be regulated. According to this aspect of the present invention, the removal of the pellicle before the cleaning of the photo-mask is not necessary any more and the photo-mask can be cleaned in a very simple and efficient manner. However, if desired, the pellicle can still be removed.

As in the first embodiment of the present invention the photo-mask can also be heated and the temperature can be set in a predetermined temperature range, which is between approximately 20° C. and 80° C., for example.

Additionally, inspecting the surface of the mask is also provided to determine the end point of the treatment, i.e., when no contaminants can be detected. Also in this embodiment, the photo-mask can be exposed to electromagnetic radiation, which is preferably in the form of an electron shower. In this case, the pellicle can be unmounted from the photo-mask.

The above and still further aspects, features, and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 depicts a chamber for cleaning the photo-mask, according to the present invention;

FIG. 2A depicts a top view of a frame glued to a mask without the membrane, according to the present invention;

FIG. 2B depicts a side view of a frame glued to a mask without the membrane, according to the present invention;

FIG. 3 schematically depicts another embodiment of the present invention, where a radiation source is a laser;

FIG. 4 schematically depicts another embodiment of the present invention, where a radiation source is a light source; and

FIG. 5 schematically depicts the reticle vacuum cleaning process of the present invention employing a variable adjustable electron beam.

### PREFERRED EMBODIMENT OF THE INVENTION

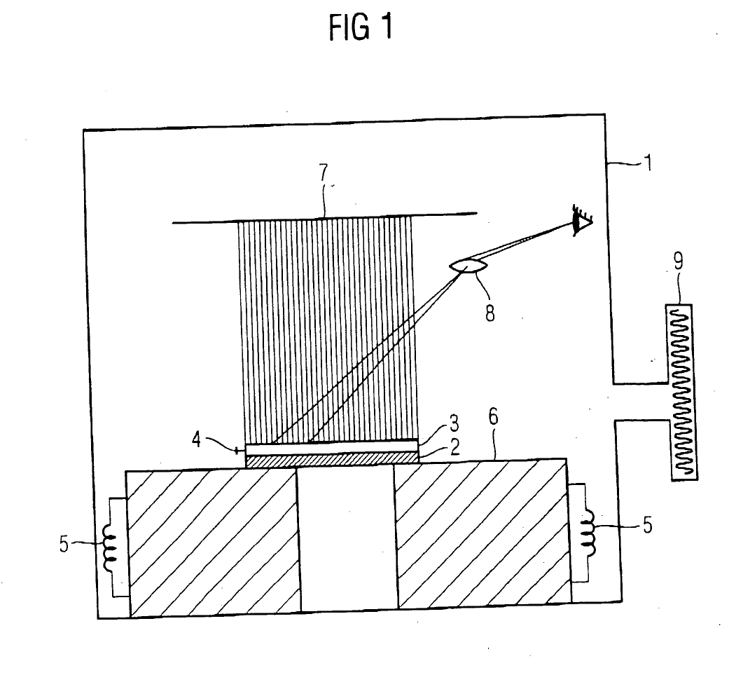

FIG. 1 schematically depicts a chamber 1 for cleaning a photo-mask 2, wherein the photo-mask is positioned in the chamber by providing a surface 6 on which a photo-mask is placed. The photo-mask 2 also includes a pellicle 3 mounted on the photo-mask, wherein a valve or venthole 4 is provided between the pellicle and photo-mask, to regulate the pressure in the space between the photo-mask and the pellicle. The surface 6 on which the photo-mask has been placed is provided with a heater 5 which controls the temperature of the photo-mask 2.

After placing the photo-mask 2 in the chamber 1, the chamber is evacuated for example, by a vacuum pump 9 to a pressure of approximately less than 100 mbar. In the chamber, an electron shower 7 is generated, and the surface of the photo-mask 8 is inspected. After inspecting the surface in regular intervals, the photo-mask no longer has crystal growth present. After no more crystals are detected on the surface of the photo-mask, the chamber is pressurized to the atmospheric pressure and the photo-mask is removed.

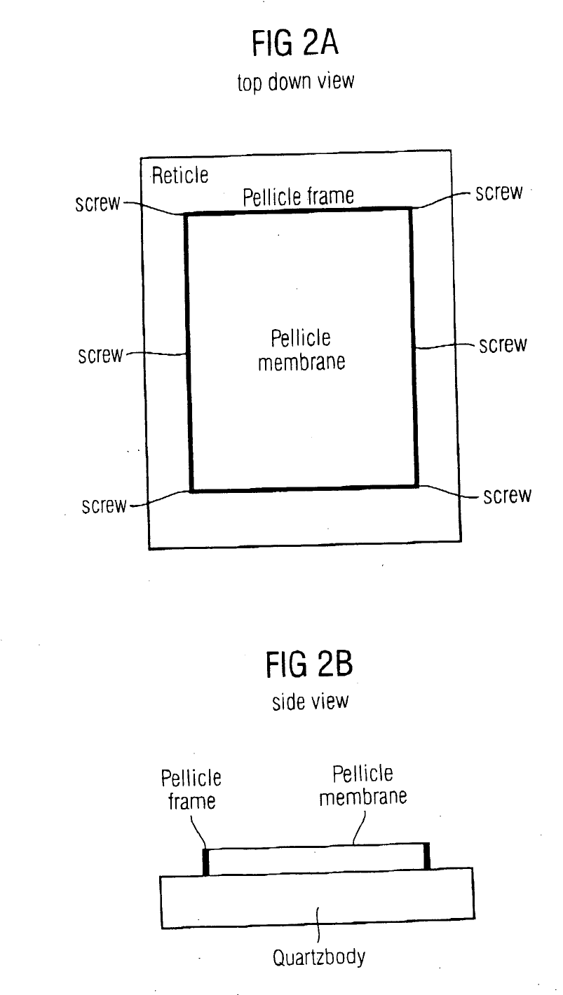

In a further embodiment of the invention as shown in FIG. 2, the frame is glued to the mask without the membrane. In a next step, the pellicle membrane is fixed to the frame by screws and a gasket which allows the removal of the pellicle membrane before subjecting the reticle to the cleaning process of the invention.

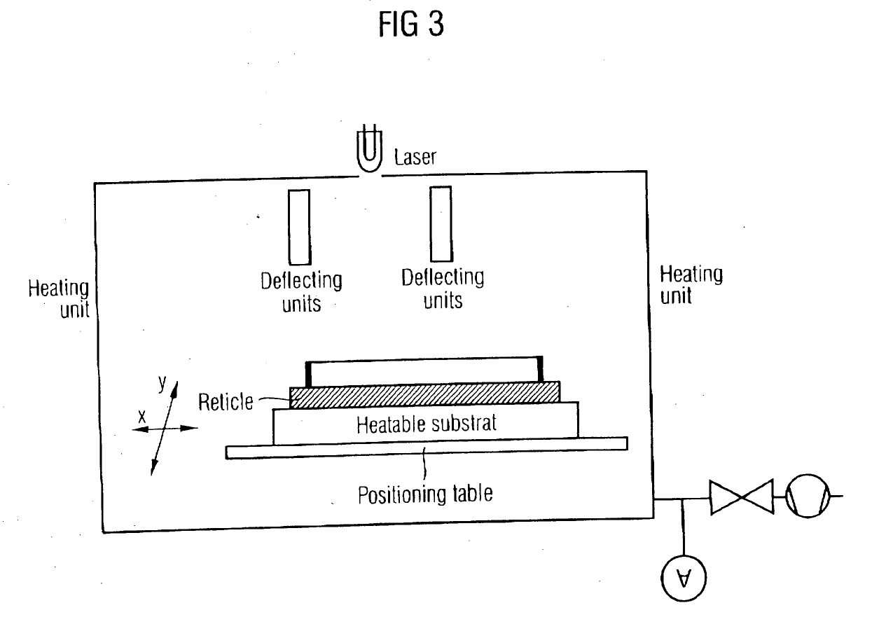

FIG. 3 schematically depicts an alternative embodiment of the invention where a radiation source is a laser.

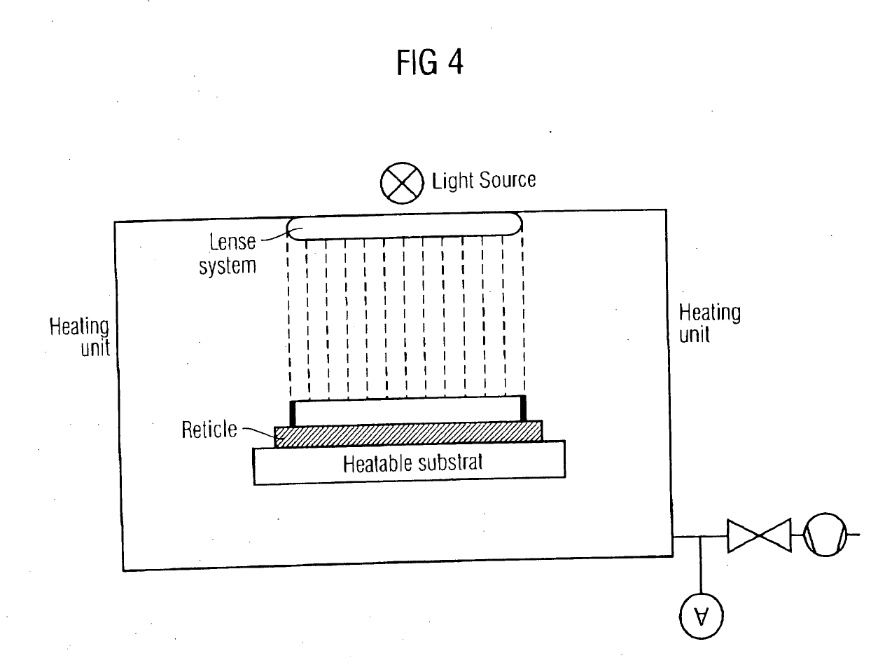

Therefore, different radiation sources such as visible or invisible light sources can all be used, which is schematically depicted in FIG. 4.

Furthermore, cleaning is possible by using a heated reticle-chuck as shown in FIG. 1 or by direct thermal radiation.

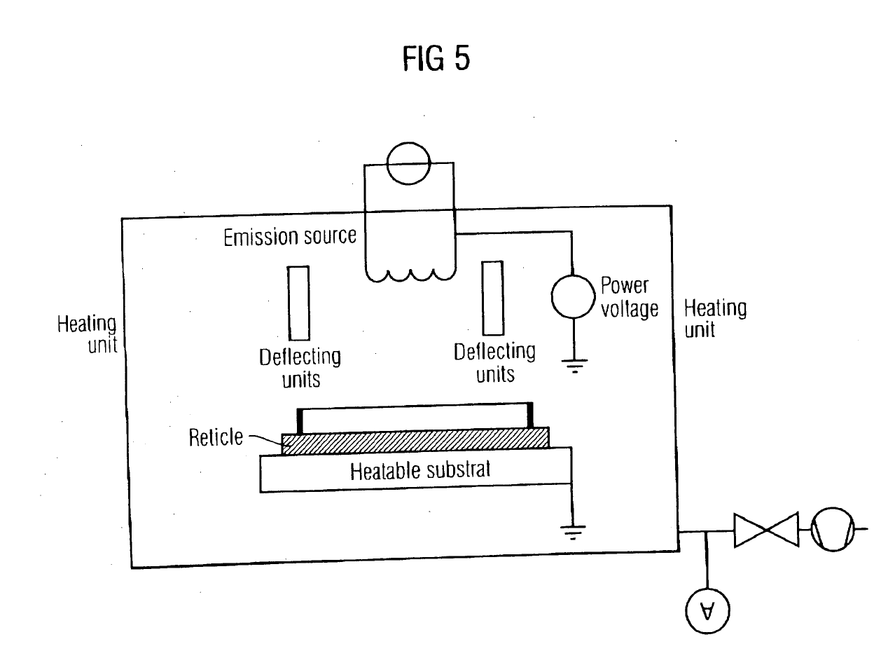

FIG. 5 shows an embodiment in which the reticle vacuum cleaning process of the invention is performed with a variable adjustable electron beam. This is especially useful when the chuck is not moved. In the case that the radiation sources are fixed, it is preferable that the chuck is moved with respect to the light sources.

Whereas the invention has been described in connection with multiple representative embodiments, it will be understood that the invention is not limited to these embodiments. On the contrary, the invention is intended to encompass all modifications, alternatives, and equivalents as may be included within the spirit and scope of the invention as defined by the appended claims while the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

1. A method for cleaning a photo-mask, comprising the steps:
providing a photo-mask including at least one crystal contaminant;
positioning the photo-mask in a chamber, wherein a pressure of the chamber is less than approximately 100 mbar; and
leaving the photo-mask in the chamber for a period of at least approximately 30 minutes to remove the at least one crystal contaminant from the photo-mask.

2. The method of claim 1, further comprising:
controlling a temperature of the photo-mask in the chamber.

3. The method of claim 2, wherein the temperature of the photo-mask is set to be in a range of approximately 20° C. to 80° C.

4. The method of claim 2, wherein the temperature of the photo-mask is set to be in a range of approximately 60° C. to 80° C.

5. The method of claim 1, further comprising:
inspecting a surface of the photo-mask.

6. The method of claim 5, further comprising:
removing the photo mask in response to detecting substantially no contaminants on the surface of the photo-mask.

7. The method according to claim 1, further comprising:
exposing the photo-mask to electromagnetic radiation or charged particles in the chamber.

8. The method according to claim 7, wherein the electromagnetic radiation is selected from the group consisting of visible light, invisible light and an electron shower.

9. The method according to claim 1, wherein the photo-mask includes a pellicle.

10. A method for removing contaminants from a surface of a photo-mask including a pellicle, comprising:
providing a photo-mask including contaminants formed on its surface;
positioning the photo-mask in a chamber using a photo-mask holder, wherein a pressure of the chamber is set to be less than 100 mbar;
leaving the photo-mask in the chamber for a period of at least 30 minutes to remove the contaminants; and
controlling the pressure in a space between the pellicle and the photo-mask using a valve or vent hole positioned between the pellicle and photo-mask.

11. (canceled)

12. (canceled)

13. The method of claim 10, further comprising:
controlling a temperature of the photo-mask in the chamber.

14. The method of claim 13, wherein the temperature of the photo-mask is set to be in a range of approximately 20-80° C.

15. The method according to claim 13, wherein the temperature of the photo-mask is set to be in a range of approximately 60-80° C.

16. The method of claim 10, further comprising:
inspecting a surface of the photo-mask.

17. The method of claim 16, further comprising:
removing the photo mask in response to detecting substantially no contaminants on the surface of the photo-mask.

18. The method according to claim 10, further comprising:
exposing the photo-mask to electromagnetic radiation or charged particles.

19. The method according to claim 18, wherein the electromagnetic radiation is selected from the group consisting of visible light, invisible light and an electron shower.

20. The method according to claim 10, further comprising:
providing a frame fixed to a reticle and the pellicle fixed to the frame by screws and a gasket.

21. The method according to claim 10, further comprising:
providing a first and a second frame; and
fixing the first frame to a reticle and the second frame to the pellicle, and wherein the frames are fixed to one another.

22. The method according to claim 21, wherein the frames are fixed to one another by screws, a gasket, or bayonet connectors.
